(19) United States
(12) Patent Application Publication
(10) Pub. No.: US 2004/0007189 A1
(43) Pub. Date: Jan. 15, 2004

(54) Agitating apparatus for mechanical game feeders

(75) Inventors: Glen Betty, Rowlett, TX (US); Jeff Nelson, Garland, TX (US)

Correspondence Address: Michael L. Diaz, Michael L. Diaz, P.C., Suite 200, 555 Republic Drive, Plano, TX, 75074, US

(73) Assignee: Outdoor Innovations

(21) Appl. No.: 10/192,395

(22) Filed: Jul. 10, 2002

(51) Int. Cl. A01K 1/00; A01K 5/00; A01K 39/00

(52) U.S. Cl. 119/57.92

(57) ABSTRACT

An apparatus for preventing game feed from clogging within a game feed dispenser. The game feed dispenser includes a container for storing the game feed. At a bottom portion of the container is a funnel having an opening. The apparatus includes a rotating plate positioned underneath the container. At least two agitating panels are affixed to the top of the rotating plate and extend through the funnel opening into the interior of the container where the game feed is stored. A motor rotates the rotating plate. Upon rotation of the rotating plate, the agitating panels also rotate. Rotation of the agitating panels within the interior of the container allows the agitating panels to break the game feed into smaller pieces, which allows the game feed to easily exit through the opening of the funnel.

### BACKGROUND OF THE INVENTION

1. Field of the Invention

This invention relates to hunting equipment. Specifically, the present invention relates to an apparatus for dispensing food to game such as deer.

2. Description of the Related Art

Hunting is a very popular and demanding sport. It is well known that deer are very nimble and sensitive to their surroundings. Because of these qualities, deer are particularly difficult to hunt. When a hunter attempts to stalk a deer, the deer may be easily frightened by the slightest of movement or sound from the hunter. Because of the difficulty encountered in stalking deer, many hunters utilize various hunting accessories for assisting in the hunt of deer. For example, many deer hunters wear camouflaged clothing to blend in with their surroundings. Such clothing makes it difficult for deer to visually detect the hunter. In addition, automatic deer feed dispensers are utilized.

Deer food dispensers are used primarily for two reasons. First, the feed dispenser distributes high protein supplements/food to the deer. Well fed deer assists in maintaining a healthy deer population. Additionally, well fed deer obviously become bigger, which is greatly desired by hunters. In addition, because of the difficulty in hunting deer, the deer feed dispenser is used to entice the deer in closer proximity to the hunters. The deer food dispensers are positioned within the wilderness to be readily available to deer.

The deer feed dispenser typically includes a large barrel container, usually being the size of a 55-gallon drum. At a bottom portion of the container is a funnel leading to an opening. Deer feed is stored within the container. The deer feed is dispensed through the funnel to a rotatably mounted plate located beneath the funnel. The deer feed falls through the funnel's opening onto the plate. The plate is rotated to spread the deer feed outwardly, away from the dispenser. The deer feed is typically high in protein and is similar to rabbit or cattle pellets having both grain interspersed with pellets. However, due primarily to moisture in the air and the consistency of the deer feed, the deer feed has a tendency to clump together and expand. This clumping and expansion makes it difficult for the feed to fall through the opening onto the rotating plate. Oftentimes, the deer feed becomes clogged within the opening. By clogging the funnel and the opening of the container, the deer feed is unable to be dispensed. Currently there is no existing device which alleviates the clogs in the opening of the funnel.

The existing dispensers do utilize a single vertically aligned plate attached to the rotating plate. However, the vertically aligned plate merely assists in slinging the deer feed outwardly from the container. The existing dispensers do not have any mechanism to break the food passing through the funnel. A devise is needed which effectively prevents clogs from forming in the opening of a deer feed dispenser.

Thus, it would be a distinct advantage to have an apparatus, which efficiently and effectively prevents clogging of a deer feed dispenser. It is an object of the present invention to provide such an apparatus.

### SUMMARY OF THE INVENTION

In one aspect, the present invention is an apparatus for use on a game feed dispenser having a rotating plate driven by a motor and a container having an interior for storing game feed. The container also includes a funnel having an opening located at the bottom of the container. The apparatus includes a base attached to the rotating plate and at least two agitating panels extending from the base through the opening of the funnel into the interior of the container. The motor rotates the rotating plate and the base, which rotates the agitating panels. The panels break the stored game feed into pieces sufficiently small to exit through the opening of the funnel.

In another aspect, the present invention is a game feed dispenser for dispensing game feed to a game. The dispenser includes a container for storing the game feed. The container has a funnel with an opening at a bottom portion of the container and a rotating plate positioned beneath the container. In addition, the dispenser includes an agitating device affixed to a top portion of the rotating plate. The agitating device has at least two panels extending through the opening of the funnel into an interior portion of the funnel. A motor rotates the rotating plate and agitating device, which rotates the agitating panels to enable the game feed in the interior to exit through the opening of the container.

In still another aspect, the present invention is an assembly for use on a game feed dispenser. The dispenser has a container for storing game feed with a funnel having an opening located on a bottom portion of the container. The assembly includes a rotating plate positioned beneath the container and an agitating device affixed to a top portion of the rotating plate. The agitating device includes at least two agitating panels extending through the opening of the funnel into an interior portion of the container. A motor rotates the rotating plate and agitating device to rotate the agitating panels to enable the game feed stored within the container to exit through the opening of the funnel.

### BRIEF DESCRIPTION OF THE DRAWINGS

FIG. 1 is a front perspective view of a deer feed dispenser in the preferred embodiment of the present invention;

FIG. 2 is a bottom perspective view of the deer feed dispenser of FIG. 1;

FIG. 3 is a top perspective view of the rotating plate of FIG. 1 removed from the deer feed dispenser and the agitating device;

FIG. 4 is a top perspective view of the agitating device removed from the deer feed dispenser and rotating plate;

FIG. 5 is a side elevational view with a partial cut away view of the agitating device and funnel;

FIG. 6 is a front view with a partial cut away view of the agitating device and the funnel; and

FIG. 7 is a top view with a partial cut away view of the mounting block, plate, funnel, and the agitating device.

### DESCRIPTION OF THE INVENTION

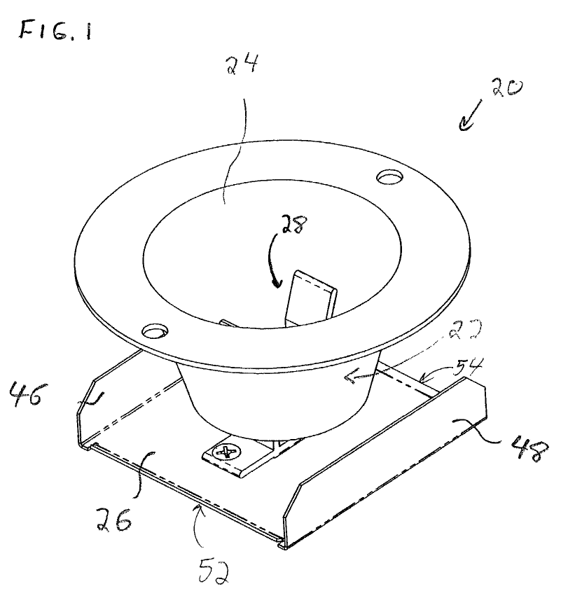

The present invention is an agitating apparatus for removing and preventing clogs of deer feed within a deer feed dispenser. FIG. 1 is a front perspective view of a deer feed dispenser 20 in the preferred embodiment of the present invention. The deer feed dispenser 20 includes a lower portion 22 of a funnel 24, a rotating plate 26, and an agitating device 28. The deer dispenser also includes a container (not shown) which houses the deer feed. The funnel attaches to an opening located on a bottom portion of the container.

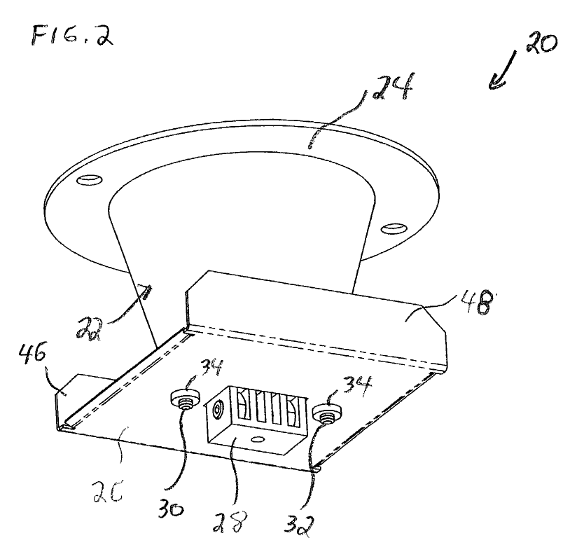

FIG. 2 is a bottom perspective view of the deer feed dispenser 20 of FIG. 1. The agitating device is preferably affixed to the rotating plate 26 by two mounting screws 30 and 32 and corresponding nuts 34 and 36. The mounting screws and nuts are positioned on the rotating plate to allow balanced rotation of the rotating plate during operation of the deer feed dispenser.

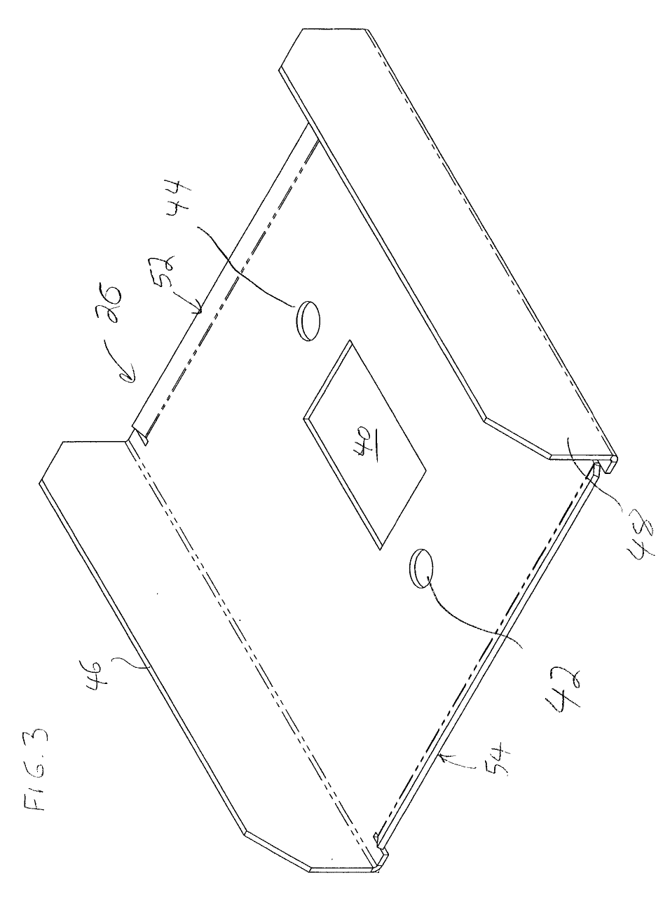

FIG. 3 is a top perspective view of the rotating plate 26 of FIG. 1 removed from the deer feed dispenser 20 and the agitating device 28. The rotating plate includes an opening 40 sized and shaped to accommodate the agitating device. Additionally, the rotating plate includes two screw openings 42 and 44 to accommodate the mounting screws 30 and 32. The rotating plate also includes two vertically inclined edges 46 and 48 positioned on opposing sides of a horizontal surface 50. On the remaining edges are located edges 52 and 54, which do not include any vertically inclined surfaces. The agitating device 28 is positioned within the opening 4.

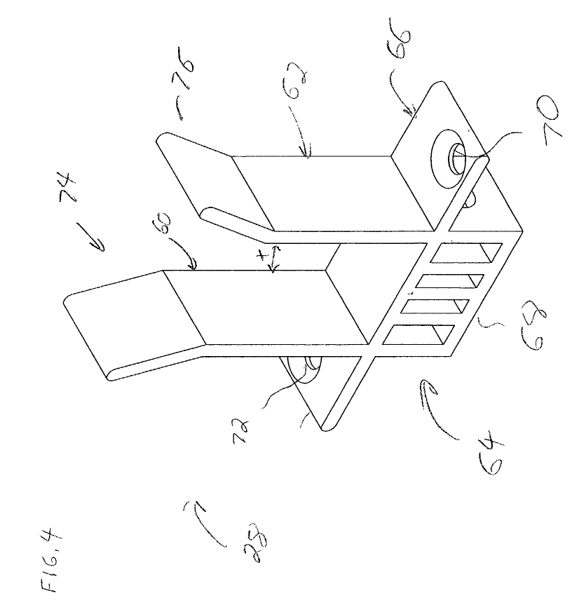

FIG. 4 is a top perspective view of the agitating device 28 removed from the deer feed dispenser 20 and rotating plate 26. The agitating device includes two agitating panels 60 and 62 attached to a base structure 64. The base structure includes a mounting plate 66 located on a mounting block 68. The mounting block is attached to a rotating shaft (not shown) running through the center of the rotating plate. The rotating shaft is driven by a motor (also not shown). Thus, the mounting plate is used to attach the rotating plate to the shaft. The mounting plate 66 includes two screw openings 70 and 72 to accommodate the set screws 30 and 32. As depicted, the openings are positioned on diagonally opposing corners of the mounting plate, thus providing symmetry to the mounting block. In alternate embodiments of the present invention, the mounting plate may include any number and positioning of the openings to facilitate attachment of the mounting plate to the rotating plate.

Each agitating panel rises perpendicularly from the horizontally aligned mounting plate. On the upper portion 74 and 76 of each agitating panel, the panel bends at approximately a ten-degree angle away from its adjacent agitating panel. Preferably, the angle of the panels is similar to the angle of the slope of the funnel 24. However, it should be understood that the bend of each panel may be at any angle allowing the deer feed to be broken into small pieces. The agitating panels are configured to be spaced a distance X from each other. The distance may be any distance, which allows the agitating panels to break up any deer feed passing to the rotating plate. The entire agitating device is preferably constructed from an extrusion process. During operation of the deer feed dispenser 20, the agitating device 28 is attached to the rotating plate 26.

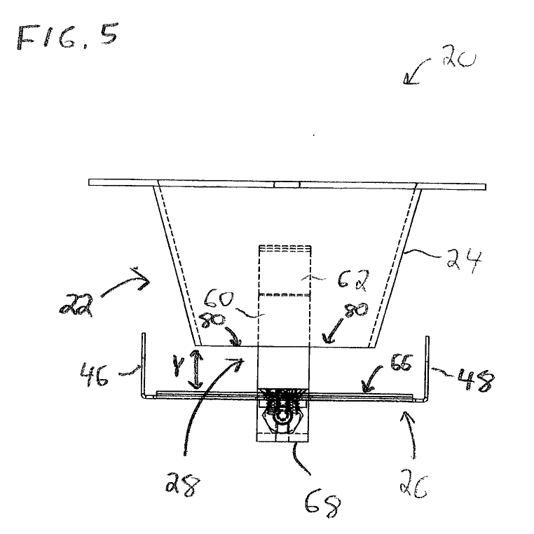

FIG. 5 is a side elevational view with a partial cut away view of the agitating device 28 and funnel 24. The agitating device is mounted to the mounting plate 66 with the two mounting screws 30 and 32. The container (not shown) and attached funnel is suspended above the agitating device and rotating plate at a distance Y. The container may also be mounted on legs, thus raising the container above the ground. The lower portion 22 of the funnel 24 includes an open end 80. The agitating panels 60 and 62 are positioned through the open end 80 within the lower portion 22 of the funnel.

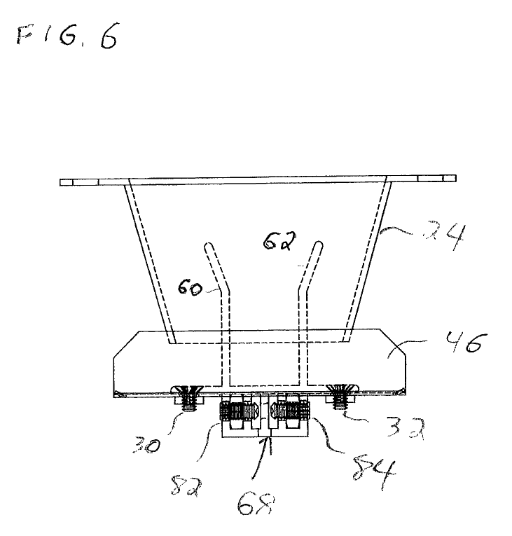

FIG. 6 is a front view with a partial cut away view of the agitating device 28 and the funnel 24. The agitating device includes two horizontally aligned cup point set screws 82 and 84, which are used for more securely fastening the mounting block 68 to the shaft (not shown). Preferably, nuts are captivated within a slot to more securely fasten the set screws to the mounting block. Both the mounting block and the set screws are positioned and configured to allow balanced rotation of the rotating plate 26. The placement of the set screws at 180 degree angles from each other allows balanced rotation of the plate.

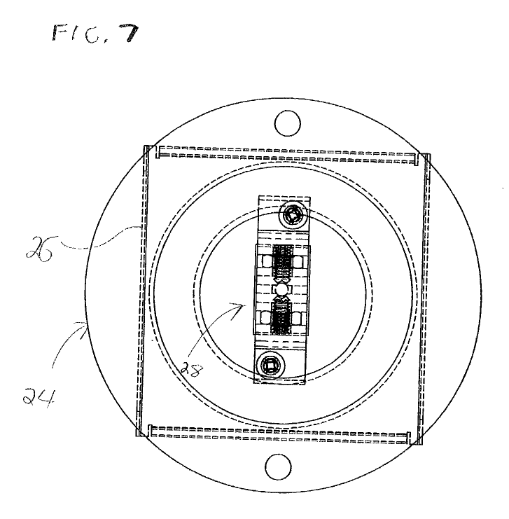

FIG. 7 is a top view with a partial cut away view of the mounting block 68 and the agitating device 28, funnel 24, and plate 26.

With reference to FIGS. 1-7, the operation of the deer feed dispenser of the present invention will now be explained. The deer feed dispenser is positioned in a location where an operator desires to feed deer. Deer feed is placed within the container having the attached funnel 24. A portion of the deer feed travels through an opening (not shown) at the bottom of the funnel and rests upon the horizontal surface 50 of the rotating plate 26. The deer feed ceases to travel through the funnel opening once enough deer feed is resting on the rotating plate, which prevents any additional deer feed from exiting through the funnel opening. The rotating plate is attached at the mounting block to a shaft of a motor (not shown), which periodically rotates the rotating plate. The motor may be manually actuated or automatically actuated from a timer. In either case, when the motor rotates the rotating plate, the rotating plate rotates. Any deer feed resting on the horizontal surface is ejected outwardly from the edges 52 and 54 of the rotating plate.

With the dispersal of the deer feed from the rotating plate 26, additional deer feed located within the interior of the container exits through the funnel's opening onto the rotating plate. Thus, deer feed is continually fed onto the rotating plate as deer feed is ejected outwardly from the rotating plate.

Simultaneously with the rotation of the rotating plate 26, the agitating device 28 rotates within the interior of the funnel 24. The two agitating panels 60 and 62 also rotate. The deer feed located within the interior of the container are broken down into smaller portions by the movement of the agitating panels 60 and 62 in such a manner as to allow the deer feed to exit through the bottom of the deer feed container.

Although the preferred embodiment of the present invention is configured with two agitating panels, in alternate embodiments of the present invention, the agitating device may be configured with any number of agitating panels. Additionally, each agitating panel may be shaped and sized as necessary to efficiently break up the deer feed.

The present invention effectively prevents clogging of deer feed dispensers dispensing deer feed to deer. The present invention may be utilized on existing deer feed dispensers or integrated within a new deer feed dispenser. The present invention is also not limited to deer feed dispensers. Any game feed dispenser may be utilized in the disclosed invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. An apparatus for use on a game feed dispenser having a rotating plate driven by a motor and a container having an interior for storing game feed, the container having a funnel with an opening at a bottom portion of the container, said apparatus comprising:
a base attached to the rotating plate; and
a plurality of agitating panels extending from said base through the opening of the funnel into the interior of the container;
whereby the motor rotates the rotating plate and said base to rotate said plurality of agitating panels to enable the game feed in the interior to exit through the opening of the funnel.

2. The apparatus for use on a game feed dispenser of claim 1 wherein said plurality of agitating panels includes two agitating panels positioned adjacent each other.

3. The apparatus for use on a game feed dispenser of claim 2 wherein each agitating panel includes an angled top portion.

4. The apparatus for use on a game feed dispenser of claim 3 wherein each agitating panel angles away from an adjacent agitating panel.

5. The apparatus for use on a game feed dispenser of claim 1 wherein the base is affixed to the rotating plate by a plurality of mounting screws.

6. The apparatus for use on a game feed dispenser of claim 1 wherein said base includes a plurality of screws positioned perpendicularly to said plurality of agitating panels, the plurality of screws providing balanced rotation of said base.

7. A game feed dispenser for dispensing game feed to a game, said dispenser comprising:
a container for storing the game feed, said container having a funnel with an opening at a bottom portion of the container;
a rotating plate positioned beneath said container;
an agitating device affixed to a top portion of the rotating plate, said agitating device having a plurality of agitating panels extending through the opening of the funnel into an interior portion of the funnel;
a motor coupled to the rotating plate;
whereby the motor rotates said rotating plate and said agitating device to rotate said plurality of agitating panels to enable the game feed in the interior to exit through the opening of the funnel.

8. The game feed dispenser of claim 7 wherein the plurality of agitating panels includes two agitating panels positioned adjacent each other on the top portion of the rotating plate.

9. The game feed dispenser of claim 8 wherein each agitating panel includes an angled top portion.

10. The game feed dispenser of claim 9 wherein each agitating panel angles away from the adjacent agitating panel.

11. The game feed dispenser of claim 7 wherein:
the rotating plate includes a second opening; and
said agitating device includes a base, the plurality of agitating panels being affixed to the base;
wherein the base is affixed to the rotating plate with the agitating panels extending through the second opening of the rotating plate.

12. The game feed dispenser of claim 11 wherein the base is affixed to the rotating plate by a plurality of mounting screws.

13. The game feed dispenser of claim 11 wherein the base includes a plurality of screws positioned perpendicularly to the plurality of agitating panels, the plurality of screws providing balanced rotation of the base.

14. An assembly for use on a game feed dispenser, the dispenser having a container for storing game feed with a funnel having an opening located on a bottom portion of the funnel and a motor, said apparatus comprising:
a rotating plate positioned beneath the funnel;
an agitating device affixed to a top portion of the rotating plate, said agitating device having a plurality of agitating panels extending through the opening of the funnel into an interior portion of the container;
whereby the motor rotates said rotating plate and said agitating device to rotate said plurality of agitating panels to enable the game feed stored within the container to exit through the opening of the funnel.

15. The assembly for use on a game feed dispenser of claim 14 wherein the plurality of agitating panels includes two agitating panels positioned adjacent each other on the top portion of the rotating plate.

16. The assembly for use on a game feed dispenser of claim 15 wherein each agitating panel includes an angled top portion.

17. The assembly for use on a game feed dispenser of claim 16 wherein each agitating panel angles away from the adjacent agitating panel.

18. The assembly for use on a game feed dispenser of claim 14
the rotating plate includes a second opening; and
said agitating device includes a base, the plurality of agitating panels being affixed to the base;
wherein the base is affixed to the rotating plate with the agitating panels extending through the second opening of the rotating plate.

19. The assembly for use on a game feed dispenser of claim 18 wherein the base is affixed to the rotating plate by a plurality of mounting screws.

20. The assembly for use on a game feed dispenser of claim 18 wherein the base includes a plurality of screws positioned perpendicularly to the plurality of agitating panels, the plurality of screws providing balanced rotation of the base.
